(19) United States
(12) Patent Application Publication
(10) Pub. No.: US 2023/0148749 A1
(43) Pub. Date: May 18, 2023

(54) ADJUSTABLE TOP TOOLBOX

(71) Applicant: Cardon Rehabilitation & Medical Equipment Ltd., Burlington (CA)

(72) Inventors: Mardig Sevadjian, Oakville (CA); John Brito, Burlington (CA)

(21) Appl. No.: 17/987,211

(22) Filed: Nov. 15, 2022

Related U.S. Application Data
(60) Provisional application No. 63/279,242, filed on Nov. 15, 2021.

(51) Int. Cl. A47B 51/00; B25H 1/12; B25H 3/00; F21V 33/00; A47B 45/00; A47B 81/00

(52) U.S. Cl. CPC A47B 51/00; B25H 1/12; B25H 3/00; F21V 33/008; A47B 45/00; A47B 81/00; F21W 2131/402

(57) ABSTRACT

The present invention relates to a top toolbox to provide additional storage on top of a toolbox without eliminating the workbench of the toolbox. The top toolbox is comprised of a cabinet, a frame guide, and lifting means to adjust the cabinet from a resting position in which the cabinet covers the frame guide to a raised position allowing access under the cabinet within the perimeter of the frame guide.

### FIELD OF THE INVENTION

The present invention relates to boxes, chests, and cabinets for storing tools (collectively “toolboxes”) and more specifically to a top toolbox which provides additional storage on top of a toolbox and is adjustable to provide access to a toolbox workbench.

### BACKGROUND OF THE INVENTION

Toolboxes, tool chests, and tool cabinets (collectively “toolboxes”) are used for storing tools and the top surface of a toolbox also provides a workbench. These toolboxes are often on wheels to enable them to be moved around, for example, in an auto mechanic garage or in a workshop.

An additional toolbox may be placed on top of a main toolbox for additional storage of tools and is referred to as a top toolbox. However, a top toolbox eliminates any workbench of the main toolbox. Alternatively, for additional storage a smaller toolbox may be placed beside the toolbox. While a side toolbox does not eliminate the main toolbox's workbench, it takes up more floor space and when it is desirable to move the main toolbox, the side toolbox must also be moved.

U.S. Pat. No. 6,889,838 discloses a toolbox that is vertically stackable with other identical toolboxes, with the aim of being easily stackable, portable, and occupying as little floor space as possible. However, the top part of said toolbox is not suitable for use as a workbench. Rather, the top part of said toolbox is only configured to connect and lock onto the bottom part of another identical toolbox.

In contrast, U.S. Pat. No. 7,367,571 discloses an all-in-one toolbox, transport, and workbench system. However, the reliance on a hand truck or dolly with vertical side rails for mounting toolboxes and workbench platforms is cumbersome and less versatile compared to stackable toolboxes that do not rely on side rails or additional mounting devices, and the workbench space is very limited.

U.S. Pat. No. 9,623,550 discloses a collapsible workstation with a workbench portion that can be raised above or lowered over a base toolbox. When raised this workbench portion forms a backboard for the top of the base toolbox, with optional side boards. This patent states that both the workbench portion and the base portion can be used to store tools. However, the workbench portion lowers over the base portion and so it is only suitable for hanging tools on a back pegboard or along the sides which does not provide substantial extra storage. The workbench portion is integral with the base toolbox.

What is needed is a top toolbox which provides additional storage and may be added to a base toolbox without eliminating a workbench.

### SUMMARY OF THE INVENTION

In an embodiment of the present invention there is a top toolbox comprised of a cabinet, a frame guide, and lifting means to adjust the cabinet from a resting position in which the cabinet covers the frame guide up to a raised position that exposes an interior of the frame guide.

In a further embodiment of the present invention, the lifting means comprises at least one lifting column under the top of the cabinet capable of raising the cabinet from the resting position to one of the raised positions.

In a further embodiment of the present invention, the cabinet comprises an outer aspect comprised of a cabinet face, two outer side walls, an outer back wall, a floor and a top, and an inner aspect comprised of two inner side walls, an inner back wall, the top and the floor; and the frame guide comprises two frame guide side walls and a frame guide back wall; and wherein when the cabinet is in resting position, each of the frame guide side walls is between one of the inner side walls and one of the outer side walls of the cabinet and the frame guide back wall is between the inner back wall and the outer back wall of the cabinet.

The lifting columns may be comprised of two lifting columns wherein one lifting column is positioned between one frame guide side wall and one inner side wall and the other lifting column is between the other frame guide side wall and the other inner side wall.

Under the floor of the cabinet there may additionally be an undercabinet framed of the outer aspect of the floor, and the inner aspect of the outer side walls and the inner aspect of the outer back wall.

The lifting columns may be comprised of a telescoping upper column within a lower column, and the lifting means may additionally be comprised of a base and a pair of supports, and the lower columns attached to the base and the upper columns attached to a support and the supports attached to the top of the cabinet at the inner aspect.

The top toolbox may additionally comprise at least one light on the top of the cabinet. The top toolbox may additionally comprise a controller to control the at least one lifting column, wherein the at least one lifting column is electrically powered, for example by and AC or DC battery. The top toolbox of may additionally comprise at least one battery to power the at least one lifting column and the at least one light.

The top toolbox may additionally comprise at least one inner cabinet light in the inner aspect of the cabinet. The top toolbox may additionally comprise a power outlet. The top toolbox may additionally comprise at least one undercabinet light under the floor of the cabinet.

The top toolbox may additionally comprise at least one battery to power the at least one lifting column, the at least one light, the at least one inner cabinet light, the power outlet and the at least one undercabinet light.

The top toolbox may additionally comprise a column switch to control the at least one lifting column through the controller and a light switch to control the at least one light.

The controller may include an anti-collision feature to control the at least one lifting column. The cabinet face of the cabinet may comprise two openings with two corresponding lockable doors.

The top toolbox may additionally comprise a tool organizing and hanging system on at least one of the frame guide back wall and frame guide sides or at least one of the frame guide back wall and frame guide sides is a tool organizing and hanging system for hanging tools.

The top toolbox may additionally comprise a workbench.

### BRIEF DESCRIPTION OF THE FIGURES

These and other aspects of the present invention will be apparent from the brief description of the drawings and the following detailed description in which:

FIG. 1 is a perspective view of a top toolbox in a raised position according to an embodiment of the present invention.

FIG. 2 is a perspective view of the top toolbox of FIG. 1 on a toolbox.

FIG. 3 is a perspective view of the top toolbox of FIG. 1 in a resting position on a toolbox.

FIG. 4 is a perspective view of the top toolbox of FIG. 1.

FIG. 5 is a front view of the top toolbox on a toolbox of FIG. 2 with a partial cut-away portion.

FIG. 6 is a side view of the top toolbox on a toolbox of FIG. 5 showing a cross-section of the top toolbox at 6-6.

### DETAILED DESCRIPTION OF THE INVENTION

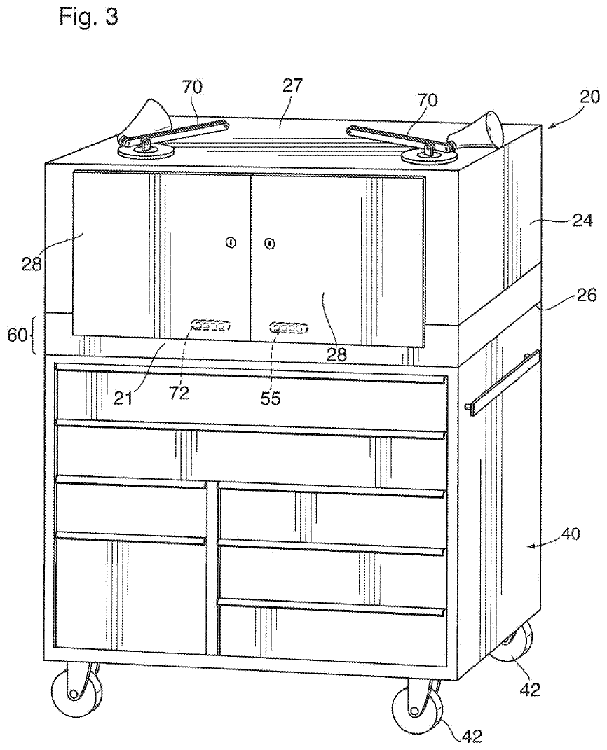

An embodiment of the present invention is a top toolbox 10 comprised of a cabinet 20 and a frame guide 30 with lifting means to adjust the cabinet 20 from a resting position in which it covers the frame guide 30 to a raised position or raised positions exposing an interior of the frame guide 30. In all the figures except for FIG. 3, the cabinet 20 is in a fully raised position. FIG. 3 shows the top toolbox 10 on a toolbox 40, and the top toolbox 10 is in a resting position with the cabinet 20 lowered over the frame guide 30 (not visible). The toolbox 40 may or may not have wheels 42; however, a toolbox with a lid (not shown) or a toolbox that otherwise prevents the top toolbox from resting on it or being adjustable is not suitable for use with the adjustable top toolbox 10 of the present invention.

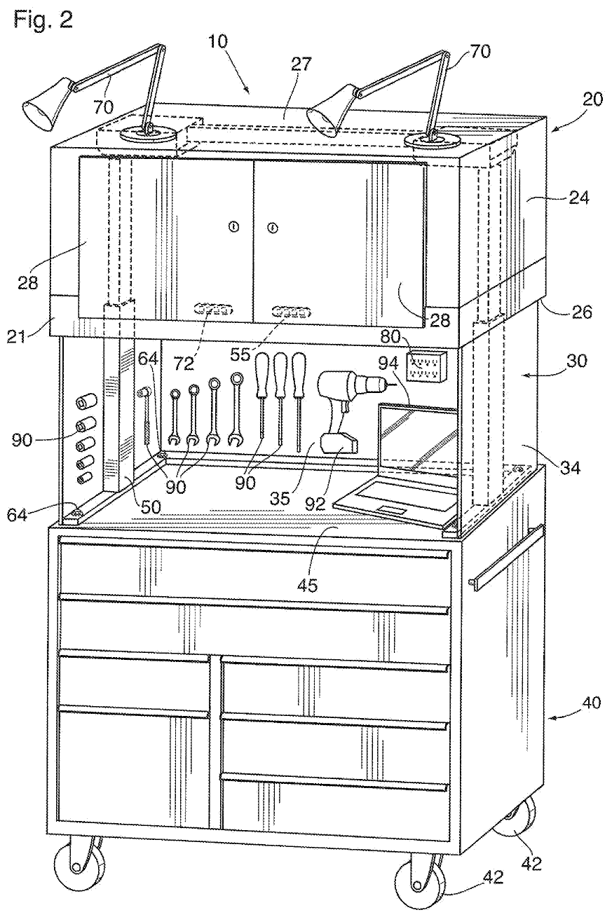

In the embodiment of the present invention shown in FIGS. 2, 3, 5 and 6, the size of the top toolbox 10 corresponds with the toolbox 40 so that the surface area of the workbench 45 on the toolbox 40 is substantially maintained.

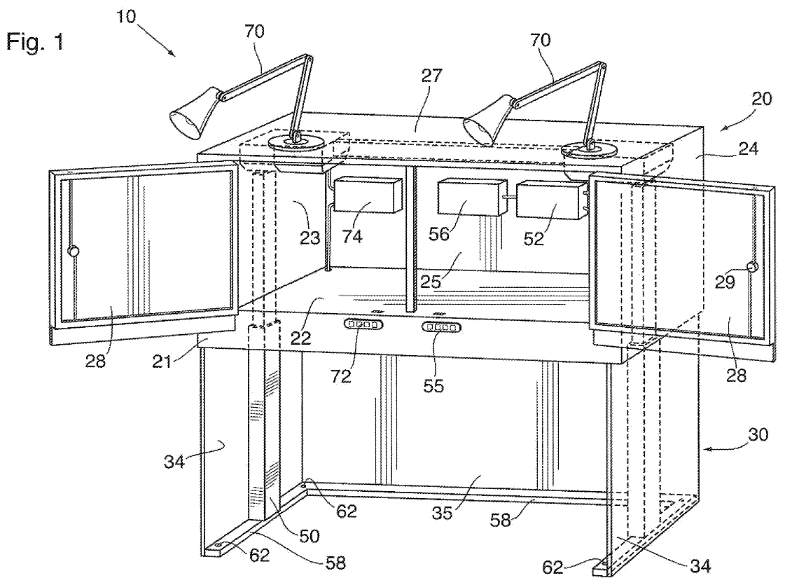

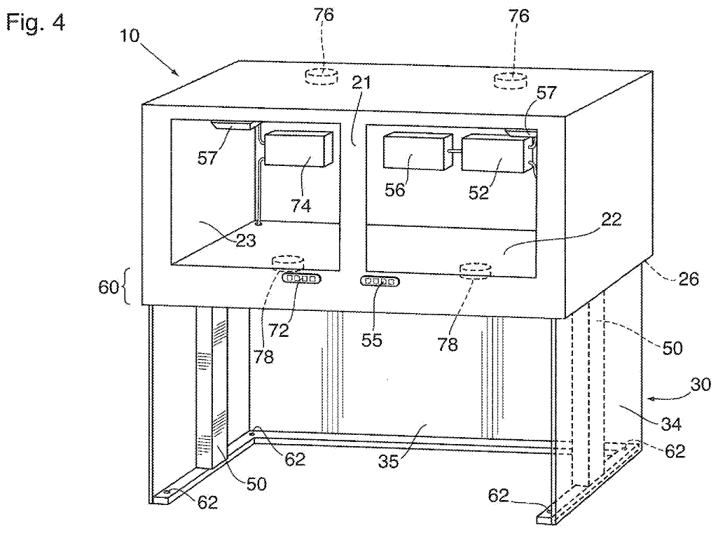

As seen in FIG. 1, the cabinet 20 has a cabinet face 21, floor 22, inner sides 23, outer sides 24, inner back wall 25, outer back wall (not shown), top 27, doors 28 and optional locks 29. FIGS. 2 and 4 show the bottom perimeter 26 of the cabinet 20. It will be understood that the cabinet 20 may have various configurations of shelves, cupboards, doors and/or drawers similarly to a toolbox 40 which may have various configurations of shelves, cupboards, doors and/or drawers.

As seen in FIGS. 1, 2, 4 and 6, the frame guide 30 has frame guide sides 34 and frame guide back wall 35.

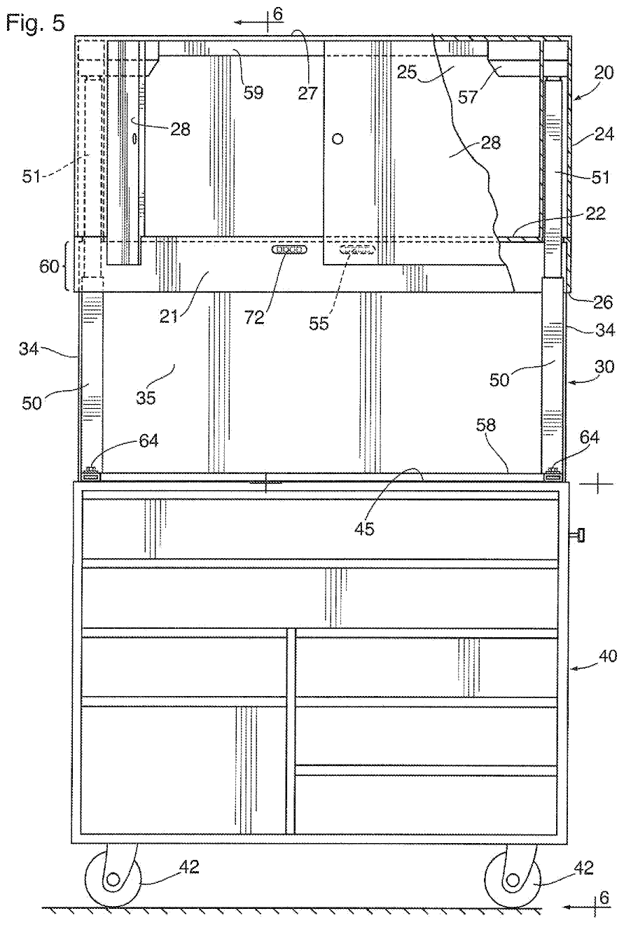

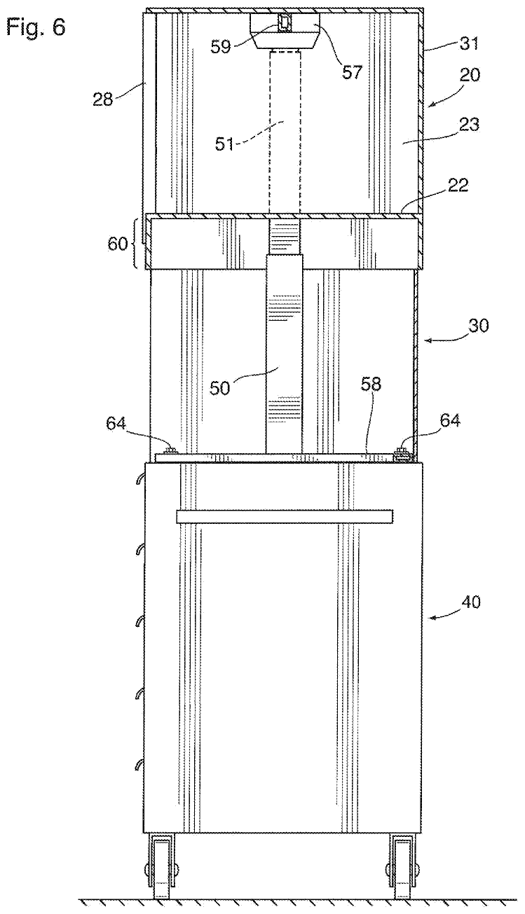

The top toolbox 10 has lifting means for the cabinet 20 to be raised and lowered electronically, powered by a battery or from an external source. In the embodiment of the invention shown in the figures, the cabinet 20 is raised or lowered through lifting means which provide support underneath top 27 and which raise or lower the top 27 and thereby the cabinet 20 is raised or lowered. As seen in FIGS. 5 and 6, the lifting means is comprised of two telescoping lifting columns 50,51 each having a lower column 50 and upper column 51. In an embodiment of the present invention, the lifting means further comprises supports 57, top bar 59 and a base 58. At the top of each upper column 51 is a support 57, and between supports 57 there is the top bar 59 connecting them.

The upper columns 51 are activated to rise or lower by pressing a column switch 55 which sends directions to a controller 52 (see FIG. 4) to extend or retract the upper columns 51 in synchrony. When the upper columns extend upwardly, the supports 57 and top bar 59 push up the top 27 of the cabinet 20. While each of the two lifting columns 50,51 are shown alongside each of the frame guide sides 34, it will be understood that other varieties of lifting columns 50 could be used, for example one lifting column in the middle or multiple lifting columns along the back, provided that the cabinet is raised or lowered safely and securely.

On either side of the top toolbox 10, the frame guide side 34 is sized to fit alongside the inner side wall 23 and between the inner side wall 23 and outer side wall 24 of the cabinet 20. At the back, the frame guide back wall 35 fits between inner back wall 25 and an outer back wall (not shown) of the cabinet 20. Each of the lifting columns 50,51 fit between the frame guide side 34 and the inner side wall 23. The column switch 55 may have buttons (not shown) to press to raise, lower, or stop/pause in lowering or raising the cabinet 20. It will be understood that a remote control or mobile application etc. could be used to activate the controller to cause the lifting columns 50,51 to move the cabinet 20 up and down.

In a further embodiment of the present invention, the lifting columns 50,51 include an anti-collision feature. With the anti-collision feature, if an object is encountered that provides resistance before the lifting column 50,51 retracts to the resting position at which the cabinet 20 covers the frame guide 30 (and the bottom perimeter 26 reaches the surface of the workbench 45), this triggers the controller to cause the lifting columns 50,51 to raise the cabinet 20 to free the object and stop above it. This anti-collision feature is useful to avoid crushing items, such as a hand, tools or a computer 94 on the workbench 45.

As shown in FIGS. 4, 5 and 6, in an embodiment of the invention, the cabinet has an undercabinet 60 since the floor 22 is raised rather than being flush with the bottom perimeter 26 of the cabinet 20. In alternative embodiments the floor 22 may be flush with the bottom perimeter 26. This undercabinet 60 allows items to remain on the workbench 45 that fit within the cavity of the undercabinet 60 when the top toolbox 10 is in resting position. FIGS. 1,2, 5 and 6 show how the top 26 is on the supports 57 and top bar 59 which enables the cabinet 20 to be raised and lowered by the extension and retraction of the upper columns 51. It will be understood that in an embodiment of the invention there is no top bar 59 but in the embodiment shown in the figures the top bar 59 adds stability. FIG. 6 shows the outer back wall 31 of the cabinet 20 and the undercabinet 60.

To support the lifting columns 50,51 there is a base 58, and in this embodiment the base 58 runs along the inner perimeter of the entire frame guide 30 to add additional stability, but in an alternative embodiment the base 58 may only run along the frame guide sides 34. The base 58 may have base holes 62 through which bolts 64 may be inserted to attach the top toolbox 10 to a toolbox 40 (with nuts, not shown, on the end of the bolts 64 within the toolbox 40) to prevent the top toolbox 10 from tipping off of the toolbox 40. In an alternative embodiment the base 58 is positioned only under any lifting columns 50,51 and there may be enough length in the base 58 for base holes 62 adjacent and on either side of the lifting columns 50,51.

The lifting columns 50,51 may be powered by an external power source, however in the embodiment shown in FIGS. 1 and 4, there is a column battery 56 to provide power for the lifting columns 50,51 to extend and retract. Having an internal battery means that the ability to raise and lower the cabinet 20 is not dependent on an external source of electricity, and thus the toolbox 40 can be moved to where it is needed, even if there is no external power source in that location.

In an embodiment of the invention shown in FIG. 1, the top toolbox has outer lights 70 turned on by a light switch 72 and powered by lights battery 74. Again, the lights could be powered by an external electrical source, but having the lights battery 74 means that the ability to light up the surrounding area is not dependent on finding an external source of electricity. The outside lights 70 may be used to light the area around the top toolbox 10. In a further embodiment, the top toolbox 10 may have inner cabinet lights 76 (see FIG. 4) to light the inside of the cabinet 20 and/or undercabinet lights 78 to light the workbench 45, which lights may be powered by the lights battery 74.

As shown in FIG. 2, in an embodiment of the invention there is a power outlet 80 for one or more plugs which may be powered by battery 56 or an external power source (not shown). The power outlet 80 may be used to provide charge for power tools, a computer 94 or cell phone charger etc.

As shown in FIG. 2, the frame guide back wall 35 and frame guide sides 34 may be used to hang tools 90. Tools may be hung with hooks or on a tool organizing and hanging system (not shown) which is either attached to any of the frame guide back wall 35 and frame guide sides 34. Alternatively, any of the frame guide back wall 35 and frame guide sides 34 may themselves be a tool organizing and hanging system (not shown). While the cabinet 20 is in raised position, larger tools 92 may be hung and a computer 94 may be in open position on the workbench 45. While the top toolbox 10 is in resting position, the size of tools left hanging will be limited by the clearance room between the inner back wall 25 and the frame guide back wall 35 and between the inner side walls 23 and frame guide sides 34, respectively. While the top toolbox 10 is in closed position, the size of items left on the workbench 45 will be limited by the size of any undercabinet 60.

In the embodiment shown in FIG. 1, the doors 28 have locks 29. To prevent activating the lights and adjust the cabinet position, a master switch for the column switch 55 and light switch 72 could be located within the locked cabinet 20 or the column switch 55 and light switch 72 could be positioned so that when the doors 28 are locked the column switch 55 and light switch 72 can not be accessed and used. It is understood that with different configurations of shelves, cupboards, doors and/or drawers in the cabinet 20, the light switch 72 and column switch 55 may be moved so that they are not accessible when the cabinet is locked up.

The top toolbox 10 may be sized for any toolbox 40 for which it will used. There are various sizes of toolboxes 40 and the top toolbox 10 may correspond to the size of the toolbox 40 or may be smaller, however it is understood that the top toolbox 10 should rest securely on top of the toolbox 40.

The frame guide 30 of the top toolbox 10 may additionally comprise a top toolbox workbench (not shown), for example, if a more durable or cut resistant workbench is desired this may be provided by the top toolbox 10. In such an embodiment the top toolbox workbench (not shown) of the top toolbox 10 would rest on top of the workbench 45 of the toolbox 40. Further in an embodiment of the present invention with a top toolbox workbench, the lifting columns 50,51 may be attached to and resting on the top toolbox workbench rather than on the base 58, which would then no longer be necessary.

The top toolbox 10 may also be constructed without inner sides 23 or without an inner back 25 and in such a case any battery 56, 74 and controller 52 could be located on the floor 22 or inside the top 27 of the cabinet 20.

While embodiments of the invention have been described in the detailed description, the scope of the claims should not be limited by the preferred embodiments set forth in the examples, but should be given the broadest interpretation consistent with the description as a whole.

What is claimed is:

1. A top toolbox comprised of a cabinet, a frame guide, and lifting means to adjust the cabinet from a resting position in which the cabinet covers the frame guide up to one or more of a raised position that exposes an interior of the frame guide.

2. The top toolbox of claim 1, in which the lifting means comprises at least one lifting column under a top of the cabinet capable of raising the cabinet from the resting position to the raised positions.

3. The top toolbox of claim 2, in which the cabinet comprises an outer aspect comprised of a cabinet face, two outer side walls, an outer back wall, a floor, and the top, and an inner aspect comprised of two inner side walls, an inner back wall, the top and the floor; and
the frame guide comprises two frame guide side walls and a frame guide back wall;
and wherein when the cabinet is in resting position, each of the frame guide side walls is between one of the inner side walls and one of the outer side walls of the cabinet and the frame guide back wall is between the inner back wall and the outer back wall of the cabinet.

4. The top toolbox of claim 3, in which the at least one lifting column comprises two lifting columns wherein one lifting column is positioned between one frame guide side wall and one inner side wall and the other lifting column is between the other frame guide side wall and the other inner side wall.

5. The top toolbox of claim 4, which additionally comprises an undercabinet under the floor of the cabinet framed by the outer aspect of the floor, the inner aspect of the outer side walls, and the inner aspect of the outer back wall .

6. The top toolbox of claim 5, wherein each of the lifting columns comprises a telescoping upper column within a lower column, and the lifting means additionally comprises a base and a pair of supports, and the lower columns are each attached to the base and the upper columns are each attached to a support and the supports are attached to the top of the cabinet at the inner aspect.

7. The top toolbox of claim 6, additionally comprising at least one light on the top of the cabinet.

8. The top toolbox of claim 7, additionally comprising a controller to control the at least one lifting column, and wherein the at least one lifting column is electrically powered.

9. The top toolbox of claim 8, additionally comprising at least one battery to power the at least one lifting column and the at least one light.

10. The top toolbox of claim 8, additionally comprising at least one inner cabinet light in the inner aspect of the cabinet.

11. The top toolbox of claim 10, additionally comprising a power outlet.

12. The top toolbox of claim 11, additionally comprising at least one undercabinet light under the floor of the cabinet.

13. The top toolbox of claim 12, additionally comprising at least one battery to power the at least one lifting column, the at least one light, the at least one inner cabinet light, the power outlet and the at least one undercabinet light.

14. The top toolbox of claim 8, additionally comprising a column switch to control the at least one lifting column through the controller and a light switch to control the at least one light.

15. The top toolbox of claim 8, in which the controller includes an anti-collision feature to control the at least one lifting column.

16. The top toolbox of claim 3, in which the cabinet face of the cabinet comprises two openings with two corresponding lockable doors.

17. The top toolbox of claim 16, wherein the interior of the frame guide additionally comprises a tool organizing and hanging system on at least one of the frame guide back wall and frame guide sides.

18. The top toolbox of claim 16 in which at least one of the frame guide back wall and frame guide sides is a tool organizing and hanging system for hanging tools.

19. The top toolbox of claim 6, in which the frame guide additionally comprises a workbench.
